(19) United States
(12) Patent Application Publication
(10) Pub. No.: US 2006/0218101 A1
(43) Pub. Date: Sep. 28, 2006

(54) Method and system for providing patent licensing information

(76) Inventor: Hyo-Jung Kim, Gyeonggi-do (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/442,048

(22) Filed: May 26, 2006

Related U.S. Application Data
(63) Continuation of application No. PCT/KR04/03080, filed on Nov. 26, 2004.

(30) Foreign Application Priority Data
Nov. 27, 2003 (KR) 10-2003-0085229

(51) Int. Cl. G06Q 99/00

(52) U.S. Cl. 705/59

(57) ABSTRACT

Method and system for providing patent licensing information are disclosed. In one embodiment, the system stores licensing information corresponding to a certain IPR if a licensor terminal sends licensing information. The system also provides search result to a licensee terminal corresponding to a keyword if a licensee terminal sends the keyword. The system further performs a license contract between the licensor and the licensee on the certain IPR if the licensee terminal sends a contract request on the certain IPR. By this, an IP search engine can provide patent licensing information with search result so that the opportunity of IP trade can increase.

### RELATED APPLICATIONS

This application is a continuation application, and claims the benefit under 35 U.S.C. §§ 120 and 365 of PCT Application No. PCT/KR2004/003080, filed on Nov. 26, 2004 and published on Jun. 9, 2005, in English, which is hereby incorporated by reference.

### BACKGROUND OF THE INVENTION

1. Field of the Invention

The present invention relates to a method and system for providing patent licensing information, especially, for helping a potential licensee to license easily and a potential licensor to get a reasonable royalty.

2. Description of the Related Technology

Along with the development and improvement of technology, filing intellectual property (IP) applications has been significantly increased in order to protect the IP rights. Korea is the third largest in the world in the number of issued patents, and the 8^{th} in the number of filed international patent applications.

But, generally how to use patents is more important than how many patent applications are filed or registered. Namely, it is more important than just filing or registration that using patents or designs in many ways as well as being protected by IP laws.

From this point of view, utilization of patents is about 37% in Korea which is the 21st in the world, this rate is very low when compared to 65% in the US.

The reason for such a low rate may be that the quality of patent applications is low or useless. However, the fundamental reason is that there are too many dormant patents and IP licensing is rarely happened.

Dormant patents and rare IP licensing come from the fact that there is no information exchange between licensors and licensees, and it is also difficult to obtain information about the existence of desirable IPs or royalty rates of IP. Thus, a common place is needed for licensors to provide information of IPs and royalty rates and for licensees to get those kinds of information.

But, according to the conventional technology transfer in a technology transfer center, when a licensor or a licensee registers brief information (e.g., technical field, technology summary, technology feature, etc.) about the technology that the licensor wants to sell or the licensee wants to buy on a web server. Then, the other party reads registered information and asks technology transfer to the technology transfer center. Namely, royalty or scope of licensing, probably the most important information, can be revealed and decided at an offline meeting.

Also, since only a small portion of the technologies is registered in the technology transfer center, it is likely that the technology that the licensee really wants may not be included therein.

### SUMMARY OF CERTAIN INVENTIVE ASPECTS

One aspect of the present invention provides a method and system for providing patent licensing information of issued IP in a search engine (e.g., www.wips.co.kr, www.uspto.gov, etc.), which provides a list of IP being disclosed or issued by patent trademark offices (PTOs), to promote a patent licensing.

Another aspect of the present invention provides a method and system for providing patent licensing information, which increases usability of technology and promotes the development of technology by eliminating dormant patents or inactivity of technology transfer.

Another aspect of the present invention provides a method and system for providing patent licensing information, which allows a licensee to obtain a technology transfer in real-time by use of licensing information included in a search result.

Another aspect of the present invention provides a method and system for providing patent licensing information, which allows a licensor to make several non-exclusive licenses or one exclusive license and helps a licensor to receive proper reward.

Another aspect of the present invention provides a method and system for providing patent licensing information, which can reduce the cost for valuation of IP and helps a licensee to use licensor's IP with low cost.

Still another aspect of the present invention provides a method for providing a licensing information of intellectual property rights (IPRs) over a network, comprising: storing licensing information corresponding to more than one IPR that is received from more than one licensor terminal, wherein the licensor is an IPR holder and the licensing information comprises a royalty and a right scope, receiving a keyword from a licensee terminal, wherein the licensee is someone who wants to use a certain IPR partially or wholly, generating a search result corresponding to the keyword, and sending the search result to the licensee terminal, wherein the search result comprises at least one IPR data and further comprises a field for indicating the licensing information if there is the licensing information relating to the IPR data.

In one embodiment, the field is indicated by a figure with color or brief licensing information according to the existence of licensing information.

The method may further comprise receiving a selection data for the information showing on the field from the licensee terminal and extracting the licensing information of IPR corresponding to the selection data to transmit to the licensee terminal.

The method may further comprise receiving a contract request to the IPR data corresponding to the licensing information from the licensee terminal and performing a license contract between the licensor and the licensee on the IPR data corresponding to the contract request.

The method may further comprise receiving a negotiation request corresponding to the IPR data from the licensee terminal, generating a negotiation request data corresponding to the negotiation request, wherein the negotiation request data comprises at least one of a personal information of the licensee and e-mail address and sending the negotiation request data to the licensor of the IPR data corresponding to negotiation request.

The licensing information may further comprise a scope of licensing. In one embodiment, the royalty is a price or rate corresponding to one selected from a group consisting of an initial payment, a running royalty, a lump sum payment, a fixed payment, a minimum/maximum royalty.

In one embodiment, the IPR is one selected from a group consisting of a patent right, a design patent right, a utility model right, a trademark right, and a copyright.

Still another aspect of the present invention provides a system for providing licensing information over a network, comprising: a receiver, receiving a licensing information corresponding to more than one intellectual property right (IPR) from more than one licensor terminal, a keyword from a licensee terminal, wherein the licensor is someone who allows the enforcement or the use of IPR, the licensing information comprises at least a royalty, and the licensee is someone who wants to use a certain IPR partially or wholly, a storage, storing the licensing information with being related to the IPR, a generator, generating a search result corresponding to the keyword and a transmitter, transmitting the search result to the licensee terminal, wherein the search result comprises at least one IPR data and further comprises a field for indicating the licensing information if there is the licensing information relating to the IPR data.

The system may further comprise a contract processor, performing a license contract between the licensor and the licensee on the IPR data corresponding to the contract request if said receiver receives a contract request for IPR corresponding to the licensing information.

In one embodiment, when a selection data for the information showing on the field is received from the licensee terminal, the licensing information of IPR corresponding to the selection data in said storage is transmitted to the licensee terminal.

Yet another aspect of the present invention provides a computer-readable medium including a program containing computer-executable instructions for performing the method for providing licensing information of intellectual property rights (IPRs) on a web server, comprising: storing licensing information corresponding to more than one IPR that is received from more than one licensor terminal, wherein the licensor is an IPR holder and the licensing information comprises a royalty and a right scope, receiving a keyword from a licensee terminal, wherein the licensee is someone who wants to use a certain IPR partially or wholly, generating a search result corresponding to the keyword, and sending the search result to the licensee terminal, wherein the search result comprises at least one IPR data and further comprises a field for indicating the licensing information if there is the licensing information relating to the IPR data.

In one embodiment, the field is indicated by a figure with color or brief licensing information according to the existence of licensing information.

The computer-readable may further comprise receiving a selection data for the information showing on the field from the licensee terminal and extracting the licensing information of IPR corresponding to the selection data to transmit to the licensee terminal.

The computer-readable may further comprise receiving a contract request to the IPR data corresponding to the licensing information from the licensee terminal and performing a license contract between the licensor and the licensee on the IPR data corresponding to the contract request.

The computer-readable may further comprise receiving a negotiation request corresponding to the IPR data from the licensee terminal, generating a negotiation request data corresponding to the negotiation request, wherein the negotiation request data comprises at least one of a personal information of the licensee and e-mail address, and sending the negotiation request data to the licensor of the IPR data corresponding to negotiation request.

### BRIEF DESCRIPTION OF THE DRAWINGS

FIG. 1 is a block diagram of system for providing patent licensing information.

FIG. 2 is a flowchart of method for providing patent licensing information according to one embodiment of the invention.

FIG. 3 shows a screen for inputting licensing information.

FIGS. 4 and 5 shows a screen for providing patent information.

FIG. 6 shows a screen for inputting contract request.

### DETAILED DESCRIPTION OF CERTAIN INVENTIVE EMBODIMENTS

Hereinafter, embodiments of the present invention will be described with accompanying drawings. Same reference number indicates same member. The intellectual property right applicable to embodiments of the present invention comprises an intangible property right such as patent right, utility model right, design patent right, trademark right, and copyright, however, I will describe the preferred embodiment mainly with patent right.

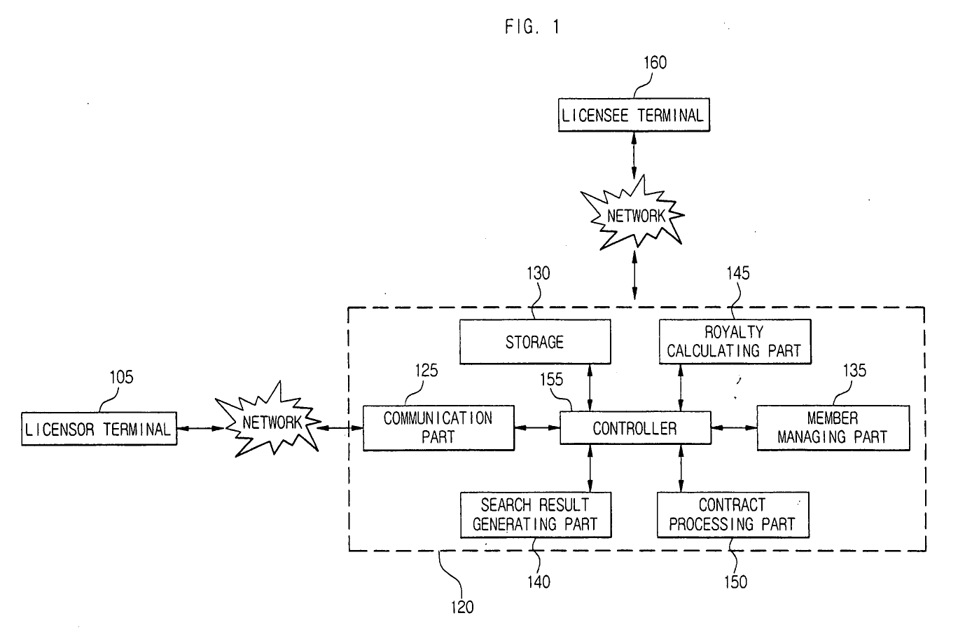

FIG. 1 is a block diagram of system for providing patent licensing information.

Referring to FIG. 1, the system for performing the method for providing the patent licensing information comprises a licensor terminal 105, licensing information providing system 120, and a licensee terminal 160.

The licensor terminal 105 accesses to the licensing information providing system 120 via network, and inputs licensing information(e.g., royalty, scope of license) of issued patent. The licensor has a legal right holder to use or allow someone to use intellectual property right (IPR) such as patent right. The royalty means a reward or compensation paid to the right holder for the use of the right such as a patent.

The licensee terminal 160 accesses to the licensing information providing system 120 via network to search issued patents, displays the searched patents, and sends a contract request from the licensee to the licensing information providing system 120. The licensee is a party who pays the royalty for using IPR to the licensor.

The licensor terminal 105 and the licensee terminal 160 can be any kind of device performing aforementioned functions, for example, computer, mobile phone, personal digital assistant (PDA), etc.

The licensing information providing system 120 comprises a communication part 125, a storage part 130, a member managing part 135, a search result generating part 140, a royalty calculating part 145, a contract processing part 150, and a controller 155. Of course, the licensing information providing system 120 can be a web server consisting of several software having same functions of the aforementioned components, not hardware components. The communication part 125 receives licensing information from the licensor terminal 105, sends a contract process result to the licensee terminal 160 when receiving a contract request from the licensee terminal 160, and sends a search result and licensing information to the licensee terminal 160 when receiving a patent search request.

The storage part 130 stores operating system (OS) of the licensing information providing system 120, patent information in an electrical file form(e.g., disclosed or issued patent specification, drawings, etc.,), licensing information, and contract information. Of course, the storage 130 can be classified into more specific storages according to the type of data to be stored. The member managing part 135 manages information(e.g., name, ID, password, etc.,) of members who subscribe the patent search and technology transfer service to the licensing information providing system 120. It is apparent that member information will be stored in the storage part 130.

The search result generating part 140, under control of the controller 155, extracts patent information corresponding to a keyword(e.g., (terminal) AND (bell)) from the storage 130 when the communication part 125 receives the keyword from the licensor terminal 105 or the licensee terminal 160, and converts extracted patent information to be displayed according to a predefined rule. At this time, patent information can comprise licensing information.

The royalty calculating part 145 calculates total amount of royalty for several patents when receiving selection data of plural issued patents from the licensee terminal 160.

The contract processing part 150 processes a contract on the issued patent between the licensor and the licensee when receiving the contract request from the licensee terminal 160. At this time, the contract processing part 150 can generate the processing result of the contract.

The controller 155 controls the communication part 125, the storage 130, the member managing part 135, the search result generating part 140, the royalty calculating part 145, and the contract processing part 150 for the licensing information providing system 120 to operate the aforementioned functions.

As described above, the licensing information providing system 120 can be a server providing information of issued patent as well as information of disclosed and issued patent. Of course, it can provide information of issued patent with licensing information only.

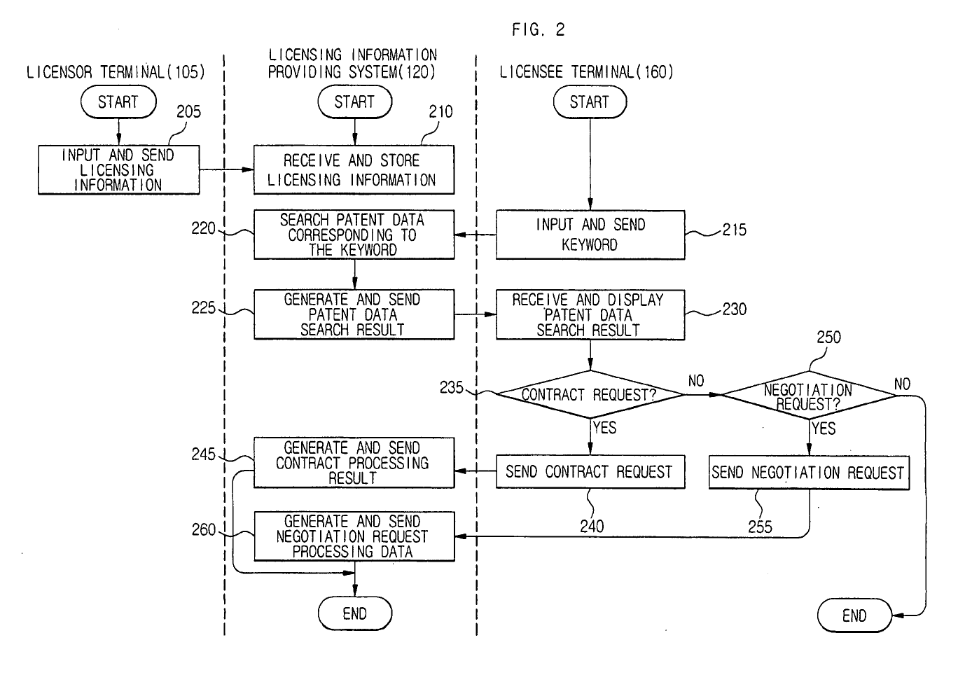

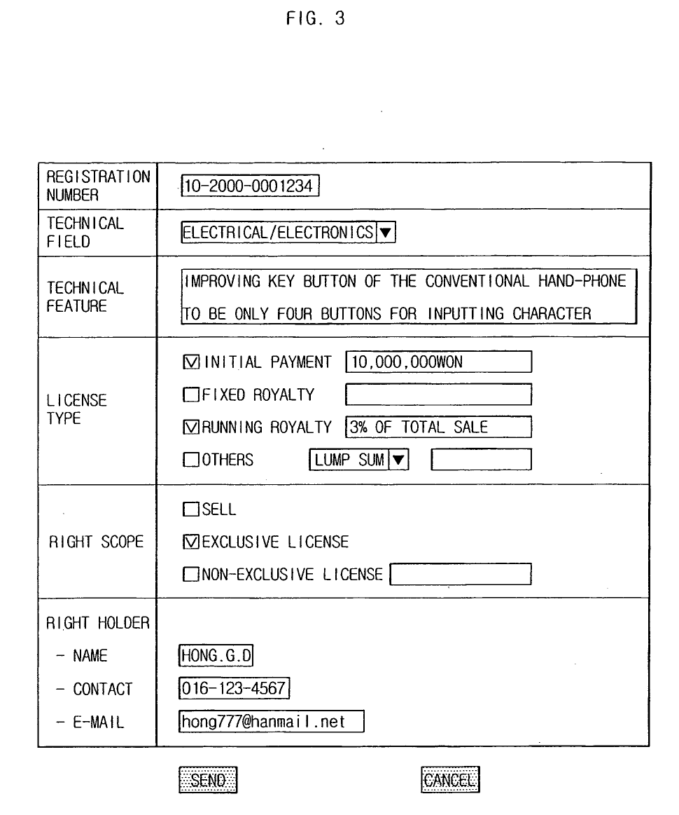

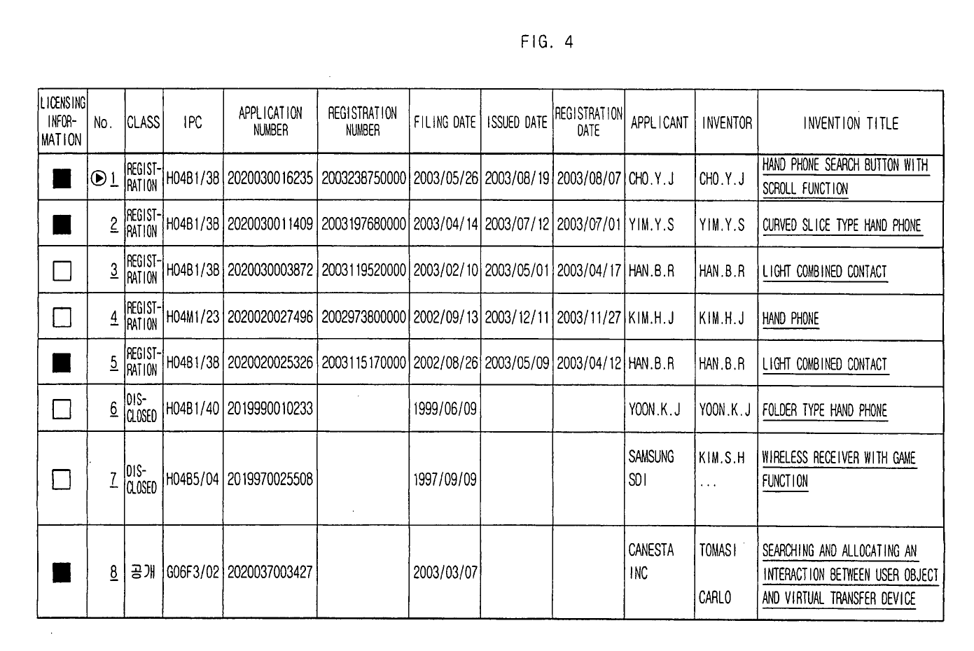

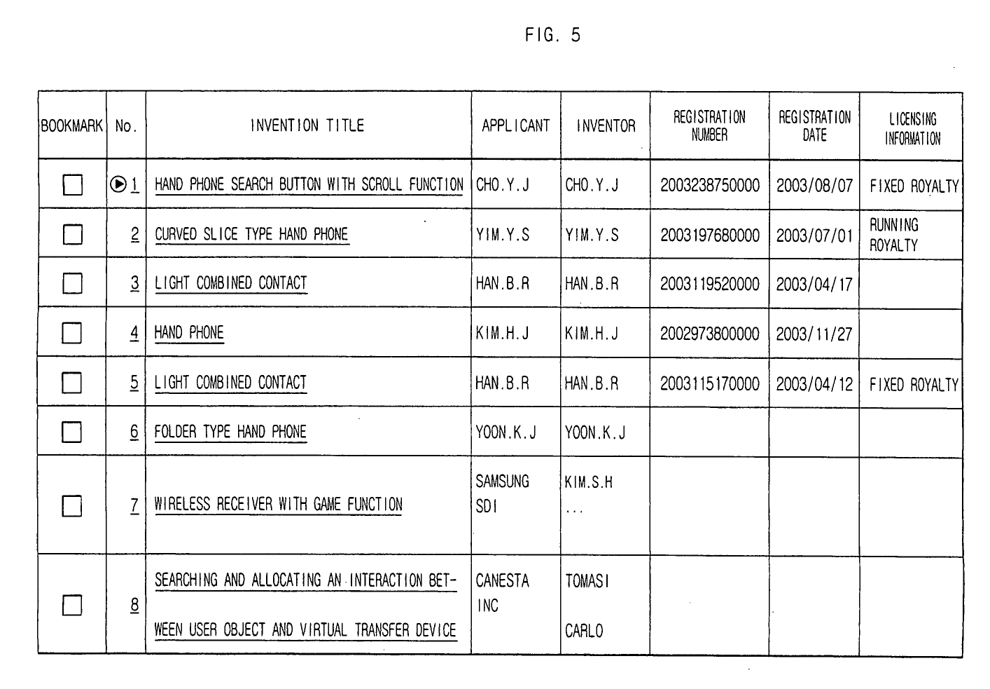

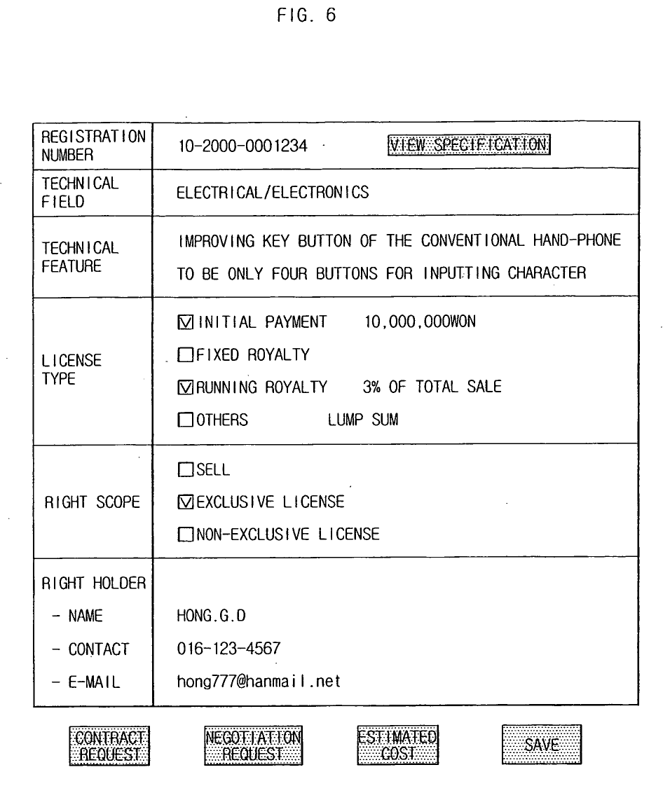

FIG. 2 is a flowchart of method for providing patent licensing information according to one embodiment of the invention, and FIG. 3 shows a screen for inputting licensing information. FIGS. 4 and 5 shows a screen for providing patent information, and FIG. 6 shows a screen for inputting contract request.

Referring to FIG. 2, at step 205, the licensor terminal 105 receives licensing information of issued patents(or disclosed patent) from the licensor, and sends licensing information to the licensing information providing system via network. Of course, it is apparent that a login step of accessing to the licensing information providing system 120, a search step of searching issued(disclosed) patents, a request step of requesting the screen for inputting licensing information to the licensing information providing system 120 and receiving the screen can be preceded.

The screen for inputting licensing information is shown in FIG. 3. Referring to FIG. 3, the screen for inputting licensing information comprises a registration number(or publication number) input region, technical field region, technical feature region, license type region, right scope region, right holder information region, etc. Of course, a part of articles in FIG. 3 will not be shown, and registration number or technical field can be automatically inserted by use of selection data or international patent class (IPC) among the search result. Also, it is possible to input data in the right holder information region only when personal information(e.g., name) identified in the login step corresponds to the applicant's name, and it is also possible to input an applicant identification code of the right holder or applicant for the purpose of inputting correct licensing information.

The license type region is for licensor to input information about what reward he wants for patent transfer or license. The reward can be varied according to the type of technology transfer: the first, fixed amount of money in case of technology trade; the second, fixed or changing royalty in case of license; the third, profit share or stock dividend in the case of investment in kind. Namely, there are an initial payment(reward at the early stage of technology transfer), a running royalty(reward in proportion to the amount of production, sales), a lump sum payment(fixed total amount of reward), a fixed payment(fixed reward in a certain year or period), a minimum/maximum Royalty, and combination thereof.

And, the running royalty can be determined by following methods: proportional to the production cost(e.g., multiplying the predetermined ratio to the production cost), proportional to the retrenchment cost(e.g., multiplying the predetermined ratio to the retrenched cost or productivity increase cost), proportional to the net profit(e.g., multiplying the predetermined ratio to net profit due to the use of technology), proportional to the total sales(e.g., multiplying the predetermined ratio to the sales or net sales of contracted product), multiplying the predetermined price to units of the contracted product(real royalty), etc.

And, the minimum royalty is one of royalty strategy when the licensor gives an exclusive license to the licensee, if the calculation of royalty is less than the normal royalty, then the calculated royalty is not applied and the predetermined fixed royalty is applied.

But, the maximum royalty means a contract that the licensee does not pay the excess of the predetermined royalty.

The aforementioned royalty calculation methods can be applied to the license type region, and the licensor can combine some royalty calculation methods.

And, in case of patent, the right scope region can comprise several selection items such as a patent transfer, an exclusive license guaranteeing the exclusive right of the licensee, a non-exclusive license as an obligatory right, etc. And, in case of non-exclusive license, the term of license, the region of license, etc., can be inputted, and if there is a special limit, then the royalty can be cheap.

Referring FIG. 2 again, at step 210, the licensing information providing system 120 stores licensing information received from the licensor terminal 105 with being related to the patent.

Then, the licensee terminal 160 receives keyword from the licensee, and sends the keyword to the licensing information providing system 120. Same as the aforementioned description, the login step can be preceded.

The licensing information providing system 120, at step 220, searches patent information corresponding to the keyword from the licensee terminal 160, and, at step 225, generates patent search result by use of the searched patent information and sends it to the licensee terminal 160 via network.

At step 230, the licensee terminal 160 outputs the patent search result on a display.

The step 215 to 230 is similar to the prior search method using Korea Institute of patent information or WIPS. But, the configuration of search result displaying screen and information comprised in the screen are different, and the search result displaying screens according to one embodiment of the present invention are shown in FIGS. 4 and 5.

Referring to FIG. 5, the search result displaying screen comprises a indication region for showing licensing information included, an IPC region, an application number region, a registration number region, and an invention title region. The indication region is for showing that licensing information corresponding to the patent is included, for example, if the indication region is black, it means that licensing information is included, also if the licensee clicks the indication region, then additional window displays licensing information corresponding to the patent(FIG. 6).

Also, referring to FIG. 5, the search result displaying screen comprises a bookmark region, a registration date region, an applicant region, an invention title region, and a licensing information region. The licensing information region can show brief licensing information if licensing information exists.

Although it is not shown in FIG. 4 and FIG. 5, a contract request button for the licensee to select a certain patent and request a licensing contract, a negotiation button for the licensee to request online or offline licensing negotiation, and an estimated cost button to calculate the estimated cost(e.g., total cost for 3 years) if plural patents are selected can be further comprised.

Referring FIG. 2 again, at step 235, the licensee terminal 160 checks that the licensee inputs the contract request for a certain patent(e.g., issued patent with licensing information). For example, the licensee clicks the contract request button after selecting a certain patent on the search result displaying screen(e.g., checking the bookmark) or viewing detailed licensing information.

On receiving the contract request, at step 240, the licensee terminal 160 sends the contract request to the licensing information providing system 120 via network, and the licensing information providing system 120 at step 245 generates a contract processing result(e.g., licensor information, licensee information, contract information including licensing information). Of course, the contract processing result can be stored in the licensing information providing system 120 or sent to the licensor terminal 105 and the licensee terminal 160.

But, if the contract request is not inputted, at step 250, the licensee terminal 160 checks that the licensee inputs the negotiation request. On receiving the negotiation request, at step 255 the licensee terminal 160 sends the negotiation request to the licensing information providing system 120 via network, and the licensing information providing system 120 generates negotiation request processing information. Of course, negotiation request processing information can be stored in the licensing information providing system 120 or sent to the licensor terminal 105 and the licensee terminal 160.

FIG. 6 shows a screen for the licensee to input a licensing contract request. Referring to FIG. 6, when the licensee requests licensing information of a certain patent, licensing information and plural function buttons as shown in FIG. 6 are displayed on the licensee terminal 160.

If the licensee wants the licensing contract to the patent, the licensee clicks the contract request button to input the license request, and if he wants additional negotiation, then he clicks the negotiation request button to input the negotiation request. Also, when the licensee wants to estimate the cost in the near future if he already made a licensing contract, then he can click the estimated cost button, and if he wants to hold to make a contract, then he can click a temporary save button(e.g., same function of shopping cart in an electrical commerce site).

As the method and system for providing patent licensing information with search result, it can induce for licensee to make a licensing contract voluntarily and also produce lots of profit for the licensor.

Also, although it is not shown in drawings, the licensee can propose a licensing condition(e.g., royalty and right scope) to a certain patent having no licensing information so that if the licensor accepts the condition, then the licensing contract can be made.

Also, it is possible that the licensing information providing system 120 can provide information about someone who read licensing information of a certain paten to the licensor so that the licensor can propose a licensing contract to the licensee to be.

The accompanying drawings and the detailed description is only for example of the present invention, and these are intended only for describing the present invention not for limiting the scope of the present invention as described in claim. Therefore, those skilled in the art can understand that various changes and equivalent embodiments can be made from the aforementioned description and accompanying drawings. Thus, the true scope of the present invention must be determined by the sprits of claims.

As described above, according to the method and system for providing patent licensing information, IP search engine can provide patent licensing information with search result so that the opportunity of IP trade can increase.

Also, at least one embodiment of the present invention can increase usability of technology and promote the development of technology by eliminating dormant patents or inactivity of technology transfer.

In addition, embodiments of the present invention can allow licensee to ask a technology transfer in real-time by use of licensing information included in a search result.

Furthermore, one embodiment of the present invention can allow licensor to make several non-exclusive licenses or one exclusive license and help the licensor to receive proper reward.

Also, at least one embodiment of the present invention can reduce the cost for valuation of IP and help the licensee to use licensor's IP with low cost.

1. A method of providing licensing information regarding intellectual property rights (IPRs) over a network, comprising:
storing licensing information, corresponding to a plurality of IPRs, that is received from a plurality of licensor terminals, wherein the licensor is an IPR holder and the licensing information comprises royalty information;
receiving a keyword from a licensee terminal, wherein the licensee is someone who wants to use a certain IPR partially or wholly;
generating a search result corresponding to the keyword; and
sending the search result to the licensee terminal,
wherein the search result comprises at least one IPR data and a field indicative of availability of the licensing information for the at least one IPR.

2. The method of claim 1, wherein the field is visually differentiated from other displayed information.

3. The method of claim 1, further comprising:
receiving a request for the licensing information associated with a selected IPR from the licensee terminal; and
extracting the licensing information of the selected IPR from the stored licensing information and transmitting the extracted information to the licensee terminal.

4. The method of claim 1, further comprising:
receiving a contract request for a selected IPR from the licensee terminal;
transmitting the contract request to the licensor terminal; and
allowing the licensor and the licensee to perform a license contract on the selected IPR based on the contract request.

5. The method of claim 1, further comprising:
receiving a negotiation request for a selected IPR from the licensee terminal;
generating negotiation request data corresponding to the negotiation request, wherein the negotiation request data comprises at least one of i) personal information of the licensee and ii) an e-mail address; and
sending the negotiation request data to the licensor of the selected IPR.

6. The method of claim 1, wherein the licensing information further comprises licensing scope information.

7. The method of claim 1, wherein the royalty information includes a price or rate corresponding to at least one of the following: an initial payment, a running royalty, a lump sum payment, a fixed payment and a minimum/maximum royalty.

8. The method of claim 1, wherein the IPR is one of the following: a patent right, a design patent right, a utility model right, a trademark right, and a copyright.

9. A system for providing licensing information over a network, comprising:
a receiver configured to receive i) licensing information corresponding to at least one intellectual property right (IPR) from at least one licensor terminal and ii) a keyword from a licensee terminal, wherein the licensor is someone who allows the enforcement or the use of an IPR, the licensing information comprises at least royalty information, and the licensee is someone who wants to use a certain IPR partially or wholly;
a storage configured to store the licensing information related to the IPR;
a generator configured to generate a search result corresponding to the keyword; and
a transmitter configured to transmit the search result to the licensee terminal,
wherein the search result comprises at least one IPR data and a field indicative of availability of the licensing information for the at least one IPR.

10. The system of claim 9, further comprising a contract processor, configured to allow the licensor and the licensee to perform a license contract on a selected IPR based on a contract request associated with the selected IPR received from a licensee terminal.

11. The system of claim 9, wherein the generator is further configured to i) extract licensing information of a selected IPR from the stored licensing information based on a request received from a licensee terminal and ii) transmit the extracted information to the licensee terminal.

12. A computer-readable medium including a program containing computer-executable instructions for performing a method of providing licensing information regarding intellectual property rights (IPRs) on a web server, the method comprising:
storing licensing information, corresponding to a plurality of IPRs, that is received from a plurality of licensor terminals, wherein the licensor is an IPR holder and the licensing information comprises royalty information;
receiving a keyword from a licensee terminal, wherein the licensee is someone who wants to use a certain IPR partially or wholly;
generating a search result corresponding to the keyword; and
sending the search result to the licensee terminal,
wherein the search result comprises at least one IPR data and a field indicative of availability of the licensing information for the at least one IPR.

13. The computer-readable of claim 12, wherein the field is visually differentiated from other displayed information.

14. The computer-readable of claim 12, further comprising:
receiving a request for the licensing information associated with a selected IPR from the licensee terminal;
extracting the licensing information of the selected IPR from the stored licensing information and transmitting the extracted information to the licensee terminal.

15. The computer-readable of claim 12, further comprising:
receiving a contract request for a selected IPR from the licensee terminal;
transmitting the contract request to the licensor terminal; and
allowing the licensor and the licensee to perform a license contract on the selected IPR based on the contract request.

16. The computer-readable of claim 12, further comprising:
receiving a negotiation request for a selected IPR from the licensee terminal;
generating negotiation request data corresponding to the negotiation request, wherein the negotiation request data comprises at least one of i) personal information of the licensee and ii) e-mail address; and
sending the negotiation request data to the licensor of the selected IPR.

17. The method of claim 6, wherein the licensing scope information includes exclusive license, non-exclusive license and sale.

18. A method of providing licensing information regarding intellectual property rights (IPRs) over a network, comprising:
receiving a search request associated with at least one IPR from a terminal owned by a potential licensee or buyer;
performing a search based on the search request; and
providing a search result to the terminal, wherein the search result comprises at least one IPR data and a field indicative of availability of licensing information for the at least one IPR.

19. The method of claim 18, wherein the licensing information comprises royalty information and licensing scope information.

20. The method of claim 18, further comprising receiving licensing information from at least one IPR owner terminal and storing the received information for an associated IPR.

21. A system for providing licensing information regarding intellectual property rights (IPRs) over a network, comprising:
a receiver configured to receive a search request associated with at least one IPR from a terminal owned by a potential licensee or buyer; and
a processor configured to i) perform a search based on the search request and ii) provide a search result to the terminal, wherein the search result comprises at least one IPR data and a field indicative of availability of licensing information for the at least one IPR.

22. A system for providing licensing information regarding intellectual property rights (IPRs) over a network, comprising:
means for receiving a search request associated with at least one IPR from a terminal owned by a potential licensee or buyer;
means for performing a search based on the search request; and
means for providing a search result to the terminal, wherein the search result comprises at least one IPR data and a field indicative of availability of licensing information for the at least one IPR.
